(19) United States
(12) Patent Application Publication
(10) Pub. No.: US 2009/0308007 A1
(43) Pub. Date: Dec. 17, 2009

(54) Composite layered panel and methodology including selected regional elevated densification

(75) Inventors: Russell A. Monk, Salem, OR (US); Lance A. Hicks, Salem, OR (US)

Correspondence Address: ROBERT D. VARITZ, P.C., 4915 SE 33RD PLACE, PORTLAND, OR, 97202, US

(73) Assignee: High Impact Technology, L.L.C.

(21) Appl. No.: 12/456,003

(22) Filed: Jun. 10, 2009

Related U.S. Application Data
(60) Provisional application No. 61/131,806, filed on Jun. 12, 2008.

(51) Int. Cl. E04C 2/20; B21D 47/00; B32B 7/02

(52) U.S. Cl. 52/309.1; 29/897.32; 428/218

(57) ABSTRACT

A heat-formation method for creating a composite, layered structural panel which possesses at least one selected area of elevated densification and reinforcement including (a) providing a pre-heat-formed, layered expanse of compressible, heat-formable, composite sheet material having a reception face and a starter thickness T₁, (b) establishing a pre-formation assembly of materials by placing on a selected area of the reception face an already heat-formed and densified island of essentially the same layered composite sheet material which defines the expanse, with such island having a thickness T₂ which is less than T₁, (c) employing heat and pressure, consolidating and compressing the expanse and the island to form, in an embedment region in the panel, an embedded-island, finished panel having an allover uniform thickness T₃ which is less than T₁, and wherein the region associated with the island has an embedment thickness T₄ which is equal to or less than T₂, and an effective density which is elevated in relation to that of other, non-embedment regions in the panel.

### CROSS REFERENCE TO RELATED APPLICATION

This application claims priority to currently co-pending U.S. Provisional Patent Application Ser. No. 61/131,806, filed Jun. 12, 2008, for “Composite Layered Panel and Methodology Including Selected Regional Elevated Densification”. The entire disclosure content of that copending provisional application is hereby incorporated herein by reference.

### BACKGROUND AND SUMMARY OF THE INVENTION

This invention pertains to a composite-material, layered structural panel, and to a methodology for creating such a panel. The invention features a specific focus on creating within the panel, at least at one location, what is referred to herein as regionally elevated densification. In particular, the structure and methodology of the invention are associated with structural panels that are compression-thermoformed, and which include, in a preferred and best-mode embodiment of, and manner of practicing, the invention, a relatively low-density compressible and thermoformable, plastic core material that is clad on opposite faces with one or more layer(s) of strand-, or fibre-, reinforced plastic material. Plastics in the core and cladding materials are compatible, and flow and merge to create united, continuum material bodies at locations where they are in contact with one another during the thermoforming process.

Structural panels are employed in many applications. In probably most of these applications, spans of such panels are desired for use which are characterized each with a substantially uniform thickness throughout. In such a setting, it is often desired to anchor external structures to such panels, and the present invention contemplates a structural panel, and a methodology for making it, in which one or more selected region(s) of the panel are specially, internally, elevatedly densified to enhance an anchoring site (or plural anchoring sites) for attaching such external structure(s). The panel proposed by the present invention is easily characterized with overall thickness uniformity.

As will be seen, the panel structure of the present invention is uniquely created by a procedure performed in the realm of pressure-thermoforming featuring the unique action, in a suitably heated environment, of forcibly embedding one, or several, pre-constructed, selectively pre-densified islands of additional panel material—sub-panels in a manner of speaking—to become integrated in an overall, larger panel which, in a finished state, will definitively possesses both one or more elevationally densified region(s) at the location(s) of such island(s), and a substantially uniform thickness throughout. In accordance with appropriate planning, and selective pre-formation and pre-densification of the employed sub-panel(s), followed by appropriate heating, pressure-consolidating/compressing and thereby post-densifying of all panel materials during the mentioned embedment process, it is possible for one easily, and with great versatility, to construct, and thereby have available, a very wide variety of uniquely tailored and formed structural panels suited to a large range of use applications.

In the description of the invention which is furnished herein, and in relation to a relevant assembly of differentiated materials having specifically different densities, the term “effective” density is employed. An “effective” density of such an assembly is determined by, and means herein, the ratio of those materials' combined, overall mass to their combined, overall volume.

Additionally, and for the purposes of description and illustration herein, a preferred manner of practicing the invention is described in conjunction with starter materials taking the two, specific forms of (a) strand-fiber-reinforced (aramid strand-reinforced, such as E-glass strand-reinforced) compressible, thermoformable plastic material—employed for panel facial cladding layers, and (b) PET (polyethylene terephthalate) material—used for a panel core layer. The plastic substances employed in these two different types of illustrative starter materials are chosen with characteristics enabling them to be readily configurationally formed by and with applied heat (in the range of around 350-400° F.) and pressure (in the range of about 5-30-psi).

Specific materials which may successfully be employed in the practice of the invention include, for panel core material, a PET material which is made and sold by Sealed Air Corporation in Saddlebrook N.J. under the product designator 6-24#, with a nominal, or starter, density of 6-lbs/ft³ and a starter thickness of 1-inches, and for facial cladding material, one or more sheets (for each face) of a 0.020-inch thickness, E-glass strand material made by Polystrand, Inc. in Montrose, Colo., sold under the trademark Polystrand®, and possessing a nominal, or starter, density of 120-lbs/ft³. In the embodiment of the panel structure disclosed herein for illustration purposes, two of these cladding are employed on each face of a core layer.

Yet another matter of background interest involves the issues of compression densification and compression pre-densification. Reference is here made to currently co-pending, U.S. Regular patent application Ser. No. ______, filed Jun. ______, 2009, for “Compression-Selective Sheet-Material Density and Thickness and Methodology”. This application describes methodology for producing composite structural panels having predetermined, final thicknesses and effective densities—a methodology which may be useful to practicers of the present invention.

In accordance with a preferred structural embodiment of the panel structure of the present invention, the proposed panel structure takes the form of: a uniform-thickness structural panel possessing at least one, selected area of elevated densification and reinforcement. The overall finished panel structure includes (a) a first panel region defined by a panel area which is other than the mentioned, at least one, selected area, and which is characterized only by a layer arrangement referred to herein as arrangement “L₁”, and (b) a second, embedment panel region defined by a panel area which is the mentioned, at least one, selected area, and which is characterized by a stacked organization of layer arrangements “L₁” and another layer arrangement which is referred to herein as arrangement “L₂”, and which has an elevated, effective density in relation to that of other, non-embedment regions in the panel.

In a more specific sense, the panel structure of this invention is one wherein each layer arrangement L₁ and L₂ is characterized by a stacked, differentiated layer-material organization which is characterized by materials M₁-M₂-M₁, where M₁ and M₂ are different, compressible thermoformable materials, and wherein material M₁ is a strand-reinforced plastic material, and material M₂ is PET material.

From a methodologic point of view, the steps of the invention which are involved in preparing such a panel include (a) providing a pre-heat-formed, layered expanse of compressible, heat-formable, composite sheet material having a reception face and a starter thickness T₁, (b) establishing a pre-formation assembly of materials by placing on a selected area in the expanse's reception face an already heat-formed and densified island of essentially the same layered composite sheet material which defines the expanse, with such island having a thickness T₂ which is less than T₁, and (c), employing heat and pressure across the entirety of the assembly, compressing and consolidating the expanse and the placed island to form, including an embedment region in the panel, an embedded-island, finished panel having an allover uniform thickness T₃ which is less than T₁, and wherein the region associated with the island has an embedment thickness T₄ which is equal to or less than T₂, and an elevated, effective density in relation to that of other, non-embedment regions in the panel

These and other features and advantages that are offered by the practice and structure of the present invention will become more fully apparent as the descriptions thereof which shortly follow are read in conjunction with the accompanying drawings.

### DESCRIPTIONS OF THE DRAWINGS

FIGS. 1 and 2 are simplified, fragmentary, schematic drawings illustrating, respectively, and very generally, pre-consolidation and post-consolidation panel structures prepared in accordance with the present invention. FIG. 2 specifically pictures a finished, uniform-thickness panel structure possessing a pair of differentially elevated-density zones, or regions.

FIGS. 3 and 4 are fragmentary views that are related to FIGS. 1 and 2, respectively. They show partially, and in greater detail, what is more schematically pictured in FIGS. 1 and 2.

### DETAILED DESCRIPTION OF THE INVENTION

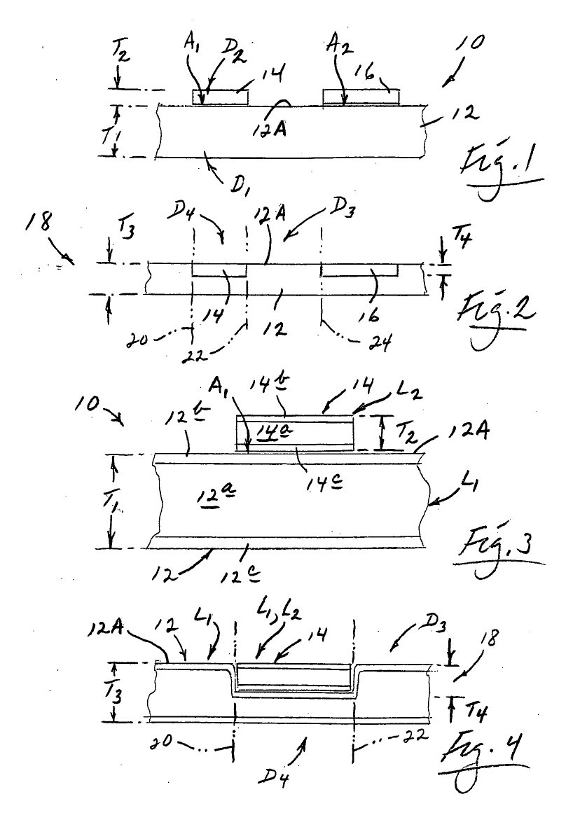

Turning now to the drawings, and referring first of all to FIGS. 1 and 2, indicated generally at 10 is what is referred to herein as a pre-formation assembly of composite sheet materials including a pre-heat-formed, layered expanse of compressible, heat-formable (thermoformable), composite sheet material, or sheet, 12 having a reception face 12A, and a starter thickness T₁. Over two selected areas A₁, A₂ of face 12A, there have been placed, to form part of this assembly, two, heat-formed, pre-densified, sub-panel islands 14, 16, respectively, each having a starter thickness T₂ which is less than previously mentioned thickness T₁. For the purpose of illustration herein, sub-panels, or islands, 14, 16, while considerably smaller in size than a sheet 12, are preferably formed of the same layer arrangement (still to be described) as that which is employed in sheet 12.

Dimension T₁ herein, for illustration purposes, is about 1.08-inches, and dimension T₂ is about ⅜-inches. In their initial stages, as illustrated in FIG. 1, sheet 12 possesses a nominal, effective, starter density D₁, and islands 14, 16 each has a starter, nominal, effective density D₂ which is greater than density D₁.

In accordance with the heat-formation zone methodology of the present invention, a methodology for creating a composite, layered structural panel, it is intended that the pre-formation assembly which is illustrated at 10 in FIG. 1 be heated in a suitable heating environment to a temperature generally in the range of about 350-400° F., and when so heated, to be compressed and consolidated to form the embedded-island, finished structural panel which is shown at 18 in FIG. 2. The pressure employed specifically to accomplish this consolidation preferably lies somewhere within the range of about 5-30-lbs/in². Specific temperature and pressure values that are entirely suitable to accomplish the intended consolidation just outlined are 375° F. and 30-lbs/in², respectively.

The finished, consolidated, regionally, elevationally densified structural panel appearing at 18 ends up with a uniform overall thickness T₃, and with the embedded, and slightly further (usually) densified islands 14, 16 each having an embedded thickness T₄. Dimension T₃ herein is about ¾-inches, and dimension T₄ is equal to or less than previously mentioned dimension T₂, or about ⅜-inches, or slightly less. The overall uniform thickness of panel structure 18 is very smooth surfaced on account of the fact that the heating and compressing process causes the compatible plastics in the two different kinds of layer materials to flow together and merge.

While it will be clear to those generally skilled in the art that the consolidated, embedded-island panel structure shown at 18 in FIG. 2 is, in an overall and “effective” sense, more densified than what is shown in FIG. 1, with the non-embedment areas having a somewhat increased effective density D₃, it will be apparent further that the selected areas, or regions, that are specifically associated with the embedded, densified islands, have, in an overall sense, what may be thought of as being regionally more elevated effective densities D₄ and reinforced areas. Thus, and referring specifically to FIG. 2, the embedment area, or region, in finished panel structure 18 lying between dash-double-dot lines 20, 22 is, in an effective density sense, more densified than other, non-embedment regions in the panel structure 18, such as the region illustrated lying between dash-double-dot lines 22, 24. The non-embedment regions in structure 18 are also referred to herein as first panel regions, and the embedment regions are also referred to as second panel regions.

Shifting attention now to FIGS. 3 and 4, these two figures, as mentioned above in the description of the drawings, present in greater-detail a portion of FIGS. 1 and 2, and more specifically, that which is shown toward the left side of FIGS. 1 and 2 where island 14 is located. FIGS. 3 and 4 illustrate more specifically the layer-arrangement makeup of sheet 12 and of the two, panel-material islands 14, 16.

As can be seen, sheet 12 is formed with what is referred to herein as a layer arrangement L₁ which includes a core layer 12a made of the earlier mentioned PET material (also referred to as M₂ material), and two, opposite-side, facial cladding layers 12b, 12c each made of two sheets of the previously mentioned Polystrand® material (also referred to as M₁ material). These stacked materials add up to produce the previously mentioned, unconsolidated, uncompressed thickness T₁ of about 1.08-inches.

With a recognition that both of the panel islands 14 16 illustrated herein are essentially the same in internal layer configuration, island 14, which is detailed in FIGS. 3 and 4, is seen to include a PET core layer 14a clad on its opposite faces with cladding layers 14b, 14c which are made up of the same fibre-strand-reinforced material which is included in previously mentioned cladding layers 12b, 12c. The organization of material layers making up each of the islands is referred to herein as a layer arrangement L₂.

Thus, in the non-embedment regions of finished structural panel 18, layer arrangement L₂ exists with a layer-material organization M₁-M₂-M₁, and in the embedment regions, there exists a layer arrangement L₁, L₂, with an overall layer-material organization M₁-M₂-M₁-M₁-M₂-M₁.

The invention thus offers a unique, uniform-thickness, embedded-island structural panel, possessing selected-elevation densification and reinforcement, and a methodology for creating such a panel with great versatility. Within this panel, reinforced, external-structure attaching sites, as many as are reasonably desired, with what specific density increases are desired, and where located, may be fabricated into what, from all outside appearances, looks to be a “normal”, flat, building-panel structure. Panel-thickness dimensionality is also completely controllable through choices of preconsolidated starter materials, and of thermoforming temperatures and pressures. Compatible thermoformable materials other than those specifically identified herein as being preferred materials, may of course be used.

Accordingly, while a preferred and best-mode embodiment of, and manner of practicing, the present invention have been illustrated and described herein, we appreciate that variations and modifications may be made without departing from the spirit of the invention.

We claim:

1. A heat-formation zone method for creating a heat-formable composite, layered structural panel which possesses at least one selected area of elevated densification and reinforcement including
providing a pre-heat-formed, layered expanse of compressible, heat-formable, composite sheet material having a reception face and a starter thickness T₁,
establishing a pre-formation assembly of materials by placing on a selected area in the expanse's reception face an already heat-formed and densified island of essentially the same layered composite sheet material which defines the expanse, with such island having a thickness T₂ which is less than T₁, and
employing heat and pressure across the entirety of the assembly, consolidating and compressing the expanse and the placed island to form an embedded-island, finished panel having an embedment region, an allover uniform thickness T₃ which is less than T₁, and wherein the embedment region has an embedment thickness T₄ which is equal to or less than T₂, and an effective density which is elevated in relation to that of other, non-embedment regions in the panel.

2. A uniform-thickness structural panel possessing at least one, selected area of elevated densification and reinforcement comprising
a first panel region defined by a panel area which is other than said selected area, and which is characterized only by a layer arrangement L₁, and
a second, embedment panel region defined by a panel area which is said selected area, and which is characterized by a stacked organization of layer arrangements L₁ and L₂, and which has an elevated, effective density in relation to that of other, non-embedment regions in the panel.

3. The panel of claim 2, wherein each layer arrangement L₁ and L₂ is characterized by a stacked, differentiated layer-material organization which is characterized by materials M₁-M₂-M₁ where M₁ and M₂ are different, compressible, thermoformable materials.

4. The panel of claim 3, wherein material M₁ is a strand-reinforced plastic material, and material M₂ is PET material.
